(19) United States
(12) Patent Application Publication
(10) Pub. No.: US 2011/0186182 A1
(43) Pub. Date: Aug. 4, 2011

(54) STEEL FOR NITROCARBURIZING AND NITROCARBURIZED PARTS

(76) Inventors: Tetsushi Chida, Tokyo (JP); Manabu Kubota, Tokyo (JP); Toshimi Tarui, Tokyo (JP); Daisuke Hirakami, Tokyo (JP)

(21) Appl. No.: 12/735,802

(22) PCT Filed: Oct. 19, 2009
(86) PCT No.: PCT/JP2009/068290

§ 371 Date: Aug. 16, 2010

(30) Foreign Application Priority Data
May 15, 2009 (JP) 2009-118994

(51) Int. Cl. B32B 15/04; C22C 38/06; C22C 38/22; C22C 38/24; C22C 38/28; C22C 38/26

(52) U.S. Cl. 148/318; 420/103; 420/105; 420/111; 420/104; 420/110; 420/106

(57) ABSTRACT

The present invention relates to a steel material giving more effective case hardening for improving the fatigue strength and is characterized by containing, by mass %, C: 0.01 to 0.3%, Si: less than 0.1%, Mn: 0.4 to 3%, Cr: 0.5 to 3%, and Al: 0.01 to 0.3%, further containing one or both of Mo: 0.2 to 1.5%, and V: 0.05 to 1.0%, having a balance of Fe and unavoidable impurities, and comprising a structure having 50% or more of bainite.

### TECHNICAL FIELD

The present invention relates to steel for nitrocarburizing provided with workability and strength and giving deep effective case hardening and nitrocarburized parts produced by nitrocarburizing this steel for nitrocarburizing.

### BACKGROUND ART

Automobiles and various industrial machines use many parts treated for surface hardening for the purpose of improving the fatigue strength. Typical surface hardening treatment methods are carburization, nitridation, and induction hardening.

Nitridation differs from the other methods in that it is treatment at a low temperature below the transformation point of steel, so has the advantage that the heat treating distortion can be reduced, but since it is treatment at a low temperature, the effective case hardening becomes shallow.

Nitridation in an ammonia atmosphere gives a high surface hardness, but the nitrogen is slow in diffusion. Usually, 20 hours or more of treatment time becomes necessary.

Nitrocarburization performed in a bath or atmosphere containing nitrogen and carbon enables the speed of diffusion of the nitrogen to be increased and enables in a few hours a 100 μm or more effective case-hardened depth to be obtained, so is a technique suited to improvement of the fatigue strength.

To obtain a steel part with a higher fatigue strength, the effective case hardening has to be made deeper. To obtain the required hardness and depth of effective case hardening, steels in which nitride-forming alloys are suitably added have been proposed (for example, see Patent Literatures 1 and 2).

Patent Literature 2 discloses steel for nitrocarburizing characterized by containing C: 0.35 to 0.65 wt %, Si: 0.35 to 2.00 wt %, Mn: 0.80 to 2.50 wt %, Cr: 0.20 wt % or less, and, Al: 0.035 wt % or less and having a balance of Fe and unavoidable impurities.

For example, the steel for nitrocarburizing disclosed in Patent Literature 2 is provided with superior fatigue strength and is free from fracture of the nitrided layer at the time of correction of bending and therefore is suitable as a material for automobile crankshafts, but with just adjustment of the composition of ingredients, there are limits to the improvement of the hardness and depth of effective case hardening.

Therefore, steels not only adjusted in compositions of ingredients, but also controlled in steel structures so as to improve the workability and nitridation properties have been proposed (for example, see Patent Literatures 3 to 8).

For example, Patent Literature 5 discloses steel for nitrocarburizing superior in cold forgeability characterized by containing, by wt %, C: 0.01 to 0.15%, Si: 0.01 to 1.00%, Mn: 0.1 to 1.5%, Cr: 0.1 to 2.0%, Al: over 0.10% to 1.00%, and V: 0.05 to 0.40%, further containing Mo: 0.10 to 1.00%, having a balance of iron and unavoidable impurities and having a core hardness after hot rolling or after hot forging of an HV of 200 or less and a limit compression rate in subsequent cold forging of 65% or more.

The steel for nitrocarburizing disclosed in Patent Literature 5 has a ferrite+bainite two-phase structure with a hardness after hot rolling of HV200 or less, but a sufficient amount of bainite is not given and therefore there are limits in terms of improvement of strength.

Patent Literature 6 discloses a material for nitrided parts superior in broachability characterized by containing, by mass %, C: 0.10 to 0.40%, Si: 0.50% or less, Mn: 0.30 to less than 1.50%, Cr: 0.30 to 2.00%, and Al: 0.02 to 0.50%, having a balance of Fe and impurity elements, and comprising a bainite structure having a hardness of HV210 or more.

The material for nitrided parts disclosed in Patent Literature 6 has a bainite structure with a hardness of HV210 or more and therefore enables easy broaching and is high in impact value and superior in surface hardness after nitrocarburization, but has a high Si concentration and cannot give a sufficient case-hardened depth.

Patent Literature 7 discloses a crankshaft characterized by containing, by mass %, C: 0.10 to 0.30%, Si: 0.05 to 0.3%, Mn: 0.5 to 1.5%, Mo: 0.8 to 2.0%, Cr: 0.1 to 1.0%, and V: 0.1 to 0.5%, having a balance of Fe and unavoidable impurities, having 2.3%≦C+Mo+5V≦3.7%, 2.0%≦Mn+Cr+Mo≦3.0%, and 2.7%≦2.16Cr+Mo+2.54V≦4.0%, having a ratio of bainite of 80% or more when austenizing a steel sample taken from a center part not affected by the nitrocarburization at 1200° C. for 1 hour, then cooling it down to room temperature so that the cooling rate when passing through 900 to 300° C. becomes 0.5° C./sec, having a Vicker's hardness measured at the cross-section of 260 to 330 HV or less, further having a surface hardness of the nitrocarburized layer at the pin part and journal part of 650 HV or more, having a depth of formation of the nitrocarburized layer of 0.3 mm or more, and having a center part hardness of 340 HV or more.

The crankshaft disclosed in Patent Literature 7 is nitrocarburized at its surface, yet is superior in machineability and at the same time is superior in high fatigue strength, but case hardening is not specifically disclosed.

### CITATIONS LIST

### Patent Literature

PLT 1: Japanese Patent Publication (A) No. 58-71357
PLT 2: Japanese Patent Publication (A) No. 4-83849
PLT 3: Japanese Patent Publication (A) No. 7-157842
PLT 4: Japanese Patent Publication (A) No. 5-065592
PLT 5: Japanese Patent Publication (A) No. 9-279295
PLT 6: Japanese Patent Publication (A) No. 2006-249504
PLT 7: Japanese Patent Publication (A) No. 2006-291310

### SUMMARY OF INVENTION

### Technical Problem

Compared with steel treated by the current mainstream art for improvement of fatigue strength, that is, carburization, in the steel treated by nitridation according to the above prior art, the effective case-hardened depth is insufficient.

The present invention has as its object the provision of steel for nitrocarburizing giving a deeper effective case hardening than the prior art so as to improve the fatigue strength and nitrocarburized parts produced by nitrocarburization of the steel for nitrocarburization.

### Solution to Problem

The inventors studied compositions and structures giving deeper effective case hardening and further the workability at the time of manufacture of parts and the surface layer hardness (Vicker's hardness, same below) of the final parts.

As a result, they discovered that Si does not contribute to the improvement of the surface layer hardness in nitrocarburization but makes the effective case-hardened depth shallower and that by making effective use of Cr and other carbonitride elements, the effective case-hardened depth remarkably increases.

The present invention was made based on the above discoveries and has as its gist the following:

(1) Steel for nitrocarburizing characterized by containing, by mass %, C: 0.01 to 0.3%, Si: less than 0.1%, Mn: 0.4 to 3%, Cr: 0.5 to 3%, and Al: 0.01 to 0.3%, further containing one or both of Mo: 0.2 to 1.5% and V: 0.05 to 1.0%, having a balance of Fe and unavoidable impurities, and comprised of a structure having, by area fraction, 50% or more of bainite.

(2) Steel for nitrocarburizing as set forth in the above (1), characterized in that an area fraction (%) of bainite and contents (mass %) of Si: Cr: and Al satisfy

[bainite area fraction]×Cr/(1.3Si+Al)>350.

(3) Steel for nitrocarburizing as set forth in the above (1) or (2), characterized in that contents (mass %) of C, Mn, Si, Cr, and Mo satisfy

$$65 ≦ 8.65 \times \sqrt{C} \times ( 1 + 4.1 Mn ) \times ( 1 + 0.64 Si ) \times ( 1 + 2.33 Cr ) \times ( 1 + 3.14 Mo ) ≦ 450$$

(4) Steel for nitrocarburizing as set forth in any of the above (1) to (3), characterized by further containing, by mass %, one or both of Ti: 0.01 to 0.3% and Nb: 0.01 to 0.3%.

(5) Steel for nitrocarburizing as set forth in any of the above (1) to (4), characterized by further containing B: 0.0005 to 0.005%.

(6) Steel for nitrocarburizing as set forth in any of the above (1) to (5), characterized in that a content of Mn is, by mass %, 1.5 to 3%.

(7) Steel for nitrocarburizing as set forth in any of the above (1) to (6), characterized by further containing one or both of Mo: 0.2 to 1.5% and V: 0.5 to 1.0%.

(8) A nitrocarburized part characterized by containing, by mass %, C: 0.01 to 0.3%, Si, less than 0.1%, Mn: 0.4 to 3%, Cr: 0.5 to 3%, and Al: 0.01 to 0.3%, further containing one or both of Mo: 0.2 to 1.5% and V: 0.05 to 1.0%, having a balance of Fe and unavoidable impurities, comprised of a structure having, by area fraction, 50% or more of bainite, having a nitrided layer at its surface, having an effective case-hardened depth of 300 μm or more, and containing one or both of Mo and V in Cr carbonitrides precipitated in the steel.

(9) A nitrocarburized part as set forth in the above (8) characterized in that an area fraction (%) of bainite and contents (mass %) of Si, Cr, and Al satisfy

[bainite area fraction]×Cr/(1.3Si+Al)>350.

(10) A nitrocarburized part as set forth in the above (8) or (9), characterized in that contents (mass %) of C, Mn, Si, Cr, and Mo satisfy

$$65 ≦ 8.65 \times \sqrt{C} \times ( 1 + 4.1 Mn ) \times ( 1 + 0.64 Si ) \times ( 1 + 2.33 Cr ) \times ( 1 + 3.14 Mo ) ≦ 450$$

(11) A nitrocarburized part as set forth in any of the above (8) to (10), characterized by further containing, by mass %, one or both of Ti: 0.01 to 0.3% and Nb: 0.01 to 0.3%.

(12) A nitrocarburized part as set forth in any of the above (8) to (11), characterized by further containing B: 0.0005 to 0.005%.

(13) A nitrocarburized part as set forth in any of the above (8) to (12), characterized in that a content of Mn is, by mass %, 1.5 to 3%.

(14) A nitrocarburized part as set forth in any of the above (8) to (13), characterized by further containing one or both of Mo: 0.2 to 1.5% and V: 0.5 to 1.0%.

In the present invention, “steel for nitrocarburizing” means steel used as a material for a nitrocarburized part.

Steel for nitrocarburizing is cold worked and, as required, cut or otherwise worked to the final product shape, then nitrocarburized to obtain a nitrocarburized part.

Alternatively, a steel slab, steel bar, or other steel material having the ingredients of the present invention is directly hot worked to the final product shape or hot worked to a shape close to the final product to obtain steel for nitrocarburizing of the present invention, then cut to the final product shape and then nitrocarburized to obtain a nitrocarburized part.

In the present invention, “nitrocarburization” means treatment for making nitrogen and carbon diffuse in the surface layer of iron or steel and hardening the surface layer. For example, there are gas nitrocarburizing, salt bath nitriding, etc.

In the present invention, the hot working in the production of steel for nitrocarburizing and the hot working in the production of nitrocarburized parts performed before nitrocarburization mean heating the steel material to 1000° C. or more, then shaping it. “Hot working” is the general term for hot rolling and hot forging. Steel for nitrocarburizing is mainly produced by hot rolling, while nitrocarburized parts are mainly produced by hot forging.

It could be confirmed that each product was a nitrocarburized part and that the surface layer was hardened and the nitrogen concentration of the surface layer rose.

In the present invention, the “effective case-hardened depth” means the distance from the surface layer to the position where HV becomes 550 with reference to the definition in the method of measurement of carburized case hardened depth of steel described in JIS G 0557.

### ADVANTAGEOUS EFFECTS OF INVENTION

The present invention enables the provision of steel for nitrocarburizing giving deeper effective case hardening in nitrocarburization and a nitrocarburized part produced by nitrocarburizing the steel for nitrocarburizing and enables the provision of a part with a small heat treating distortion and a high fatigue strength.

### BRIEF DESCRIPTION OF DRAWINGS

FIG. 1 is a TEM micrograph of effective case hardening of a part obtained by nitrocarburizing a conventional steel material.

FIG. 2 is a view showing the results of analysis by an X-ray analyzer of the ingredients of Cr carbonitrides of effective case hardening of a part obtained by nitrocarburizing a conventional steel material.

FIG. 3 is a TEM micrograph of effective case hardening of a part obtained by nitrocarburizing a steel material of the present invention.

FIG. 4 is a view showing the results of analysis by an X-ray analyzer of the ingredients of Cr carbonitrides of effective case hardening of a part obtained by nitrocarburizing a steel material of the present invention.

FIG. 5 is a schematic view showing a ½ cross-section of a gear produced by an example of the present invention.

FIG. 6 is a view showing the relationship between the [bainite area fraction]×Cr/(1.3Si+Al) and effective case-hardened depth of invention examples and comparative examples.

### DESCRIPTION OF EMBODIMENTS

First, the reasons for limiting the composition of ingredients of the steel material in the present invention will be explained. The limitations of the composition of ingredients also apply to the steel for nitrocarburizing and nitrocarburized parts of the present invention.

C is an element required for securing hardenability and obtaining a bainite structure and is an element making alloy carbides precipitate during nitrocarburization and contributing to precipitation strengthening. If C is less than 0.01%, the required strength cannot be obtained, while if over 0.3%, the strength before forging becomes too high and working becomes difficult. Therefore, the range of concentration of C was limited to 0.01 to 0.3%. To obtain a sufficient amount of precipitation strengthening, over 0.05% is preferable. To facilitate forging, less than 0.15% is preferable and less than 0.10% is more preferable.

Si is an element required as a deoxidizing agent, but in the present invention, does not contribute to improvement of the surface layer hardness in the nitrocarburization and makes the effective case-hardened depth shallower, so its content has to be limited. Therefore, the range of concentration of Si was limited to less than 0.1%. Further, to obtain a deeper effective case hardening, it is more preferably 0.05% or less.

Mn is an element required for securing hardenability and obtaining a bainite structure. If Mn is less than 0.4%, sufficient hardenability cannot be secured, while if over 3%, the structure becomes martensite, the strength before forging becomes too high, and working becomes difficult. Therefore, the range of concentration of Mn was limited to 0.4 to 3%. To obtain a sufficient hardenability, a more preferable range of concentration of Mn is 1.5 to 3%.

Cr is an element forming carbonitrides with N entering during nitrocarburization and C in the steel and remarkably raising the hardness of the surface by precipitation strengthening of the carbonitrides. If the amount of Cr is less than 0.5%, sufficient effective case-hardened depth cannot be obtained, while if over 3.0%, the effect becomes saturated, so the range of concentration of Cr was limited to 0.5 to 3%.

Al is an element required as a deoxidizing element and, further, forms nitrides with N entering at the time of nitrocarburization to remarkably raise the hardness of the surface. Al, like Si, is an element which makes the effective case hardening shallower if excessively added, If Al is less than 0.01%, the steel cannot be sufficiently deoxidized at the time of production and the rise in hardness of the surface will sometimes become insufficient. If Al is added over 0.3%, the effective case hardening becomes shallower. Therefore, the range of concentration of Al was limited to 0.01% to 0.3%.

Mo and V are elements effective for securing the hardenability and obtaining a bainite structure. One or both are added. Further, they are elements forming carbonitrides with the N entering at the time of nitrocarburization and the C in the steel or forming composite carbonitrides with Cr and thereby required for obtaining high surface layer hardness and deep effective case-hardened depth.

If Mo is less than 0.2% and V is less than 0.05%, the above effects cannot be sufficiently obtained, while if Mo is over 1.5% and V is over 1.0%, an effect commensurate with the cost cannot be obtained, so the range of concentration of Mo was limited to 0.2 to 1.5% and the range of concentration of V was limited to 0.05 to 1.0%. A more preferable range of concentration of V is 0.5 to 1.0%.

The concentrations of C, Mn, Si, Cr, and Mo are preferably ones whereby the multiplying factor expressed by the following formula is preferably 65 or more from the viewpoint of securing hardenability and 450 or less from the viewpoint of ease of cold working and forging.

$$Multiplying factor = 8.65 \times \sqrt{C} \times ( 1 + 4.1 Mn ) \times ( 1 + 0.64 Si ) \times ( 1 + 2.33 Cr ) \times ( 1 + 3.14 Mo )$$

The “multiplying factor” is a numerical value showing the extent of effect of alloy elements on the hardenability. The C, Mn, Si, Cr, and Mo in the above formula are mass percent concentrations of the elements.

Ti and Nb are both elements effective for securing hardenability and obtaining a bainite structure. One or both are preferably added. Ti and Nb, like Mo and V, are elements effective for forming carbonitrides with the N entering at the time of nitrocarburization and the C in the steel and obtaining a high surface layer hardness and deep effective case-hardened depth.

If Ti or Nb is less than 0.01%, the above effects cannot be sufficiently obtained, while if over 0.3%, they cannot be completely solubilized, so the effects become saturated. Therefore, the ranges of concentration of Ti and Nb are preferably made 0.01 to 0.3%.

B is an element effective for raising the hardenability and obtaining a bainite structure and therefore is preferably added. If B is less than 0.0005%, the effects cannot be sufficiently obtained, while if over 0.005%, the effects become saturated, so the range of concentration was limited to 0.0005 to 0.005%.

Next, the reason for limiting the structure of the steel for nitrocarburizing to a structure having, by area fraction, 50% or more of bainite in the present invention will be explained. To improve the effective case-hardened depth, it is necessary to sufficiently strengthen the steel by precipitation strengthening at the time of nitridation and raise the hardness of the steel. Therefore, it is necessary to make the alloy elements necessary for precipitation sufficiently form solid solutions with the steel before the nitrocarburization. For this, the structure is suitably martensite or bainite.

On the other hand, if considering the cold forgeability or cuttability, a structure mainly comprised of martensite is not suitable since the hardness becomes too high. From the above, a structure mainly comprised of bainite is optimal. To cause sufficiently precipitation strengthening, by area fraction, 50% or more of the structure has to be bainite. To more effectively cause precipitation strengthening, by area fraction, a 70% or more bainite structure is preferable. Further, the remaining structure other than the bainite is comprised of one or two of ferrite, pearlite, and martensite.

The bainite of the steel structure can be determined by mirror polishing a sample, then etching it by a Nital solution and examining the result under an optical microscope. For example, it is possible to observe and photograph five fields of regions corresponding to positions of measurement of hardness under an optical microscope by 500× power, visually determine the bainite parts, and analyze these by image analysis to find the area fraction of the bainite.

When not hot working the steel for nitrocarburizing of the present invention, but cold working or cutting it etc. to obtain the final product shape, then nitrocarburizing it to obtain a nitrocarburized part, the structure of the steel for nitrocarburizing has to be 50% or more bainite.

Even when hot forging or otherwise hot working a steel material having a composition of ingredients similar to the steel for nitrocarburizing of the present invention and, as required, cutting it etc. to obtain the final product shape, it is preferable that 50% or more of the structure of the steel material be bainite. This is because in the final hot working, steel for nitrocarburizing of the present invention having bainite of 50% or more is easy to obtain.

The advantageous effects of the present invention can be obtained by cold working the steel for nitrocarburizing of the present invention, then cutting it etc. as required, then nitrocarburizing it to produce a nitrocarburized part.

A steel material having a composition of ingredients similar to the above steel for nitrocarburizing may be hot forged or otherwise hot worked to obtain a bainite area fraction of 50% or more, then cut etc. as required to obtain the final product shape, then nitrocarburized to obtain a nitrocarburized part. In this case, the steel material does not necessarily have to have bainite as 50% or more of its structure.

The steel material may be used as cast or may be cast, then hot forged, hot rolled, or otherwise hot worked.

The nitrocarburized part of the present invention has to have, by area fraction, 50% or more of its structure as bainite. The area fraction of bainite of a nitrocarburized part can be found by a method similar to the area fraction of bainite of steel for nitrocarburizing.

The mechanism by which nitrocarburization causes a surface layer to harden may be considered precipitation strengthening by an alloy or iron nitride or solution strengthening by nitrogen. The inventors took note of and investigated in detail the alloy nitrides considered to be most effective for strengthening.

The inventors discovered that to obtain a high surface layer hardness and deep effective case-hardened depth in nitrocarburization, it is effective to add Cr and one or both of Mo and V to the steel in combination and to make the Cr carbonitrides include Mo or V. By the Cr carbonitrides precipitating at the time of nitrocarburization including Mo or V, the strength effectively rises and, further, nitrogen is kept from dispersing at the time of nitrocarburization, so a deep effective case hardening can be obtained.

In the present invention, if nitrocarburizing the steel or part for 10 hours or more, it is possible to obtain steel or a part with an effective case-hardened depth of 300 μm or more and a surface layer hardness of HV700 or more.

Whether the Cr carbonitrides contain Mo and V can be analyzed using an X-ray element analyzer etc. The precision of the X-ray element analyzer etc. should be one enabling detection of elements contained in amounts of 0.5% or more.

In a nitrocarburized part obtained by cold working steel for nitrocarburizing having the composition of ingredients prescribed in the present invention and having, by area fraction, 50% or more of bainite, then nitrocarburizing it, the advantageous effects of the present invention can be obtained by including in the Cr carbonitrides precipitated in the steel one or both of Mo and V.

Further, in a nitrocarburized part obtained by hot working a steel material having the composition of ingredients prescribed in the present invention to obtain a structure having 50% or more of bainite, then nitrocarburizing it, it is possible to obtain the advantageous effect of the present invention by making the Cr carbonitrides precipitated in the steel include one or both of Mo and V.

The inventors discovered that to obtain deeper effective case hardening by nitrocarburization, it is effective that the bainite area fraction before nitrocarburization and the contents of Cr, Si, and Al satisfy

[bainite area fraction]×Cr/(1.3Si+Al)>350

Here, the “bainite area fraction” is a percentage, while the Si, Cr, and Al are mass percent concentrations. The remaining structure other than the bainite consists of one or two of ferrite, pearlite, and martensite. The bainite area fraction does not change before and after nitrocarburization, so it is sufficient that the above condition be satisfied by the bainite area fraction after nitrocarburization. If this condition is satisfied, in general nitrocarburization, 10 hours or so of treatment time can give an effective case-hardened depth of 330 μm or more.

Next, an example of the method of production of the steel for nitrocarburizing and nitrocarburized parts of the present invention will be explained.

A 50% or more bainite structure is obtained by controlling the hot rolling for producing the steel for nitrocarburizing or the hot forging for producing a nitrocarburized part. Specifically, it is obtained by defining the temperature of the hot rolling or hot forging of the steel bar or the cooling rate after hot rolling or hot forging.

If the heating temperature before hot rolling and hot forging is less than 1000° C., the deformation resistance rises and costs increase and, also the added alloy elements will not sufficiently solubilize, so the hardenability will become lower and the bainite area fraction will become lower. Therefore, the heating temperature before rolling and before forging is preferably 1000° C. or more. If the heating temperature is over 1300° C., the austenite grain boundaries will coarsen, so the heating temperature is preferably 1300° C. or less.

If the cooling rate after the hot rolling or hot forging to cooling to 500° C. becomes, with the ingredients of the steel material of the present invention, less than 0.1° C./sec, the bainite area fraction will fall or the ferrite-pearlite structures will increase, so the cooling rate is preferably 0.1° C./sec or more. If the cooling rate exceeds 10° C./sec, the martensite will increase, whereby the strength before cold forging or cutting will become higher leading to increased costs, so the cooling rate is preferably 10° C./sec or less.

A part produced by using steel for nitrocarburizing produced by hot rolling under the above conditions and cold working it (for example cold forging and cutting it) to a predetermined shape of a part may be improved in fatigue strength while suppressing strain by nitrocarburizing it.

To make the Cr carbonitrides include Mo or V, it is necessary to include one or both of Mo: 0.2 to 1.5% and V: 0.05 to 1.0%, make the structure contain 50% or more of bainite, and nitrocarburize it.

The nitrocarburization is, for example, performed by gas soft-nitridation at 580° C. by a N₂+NH₃+CO₂ mixed gas for 10 hours, whereby a surface layer hardness of HV700 or more and an effective case-hardened depth 300 μm or more of case hardening are obtained. That is, it is possible to obtain a sufficient surface layer hardness and a deeper effective case hardening compared with a conventional steel material in an industrially practical time.

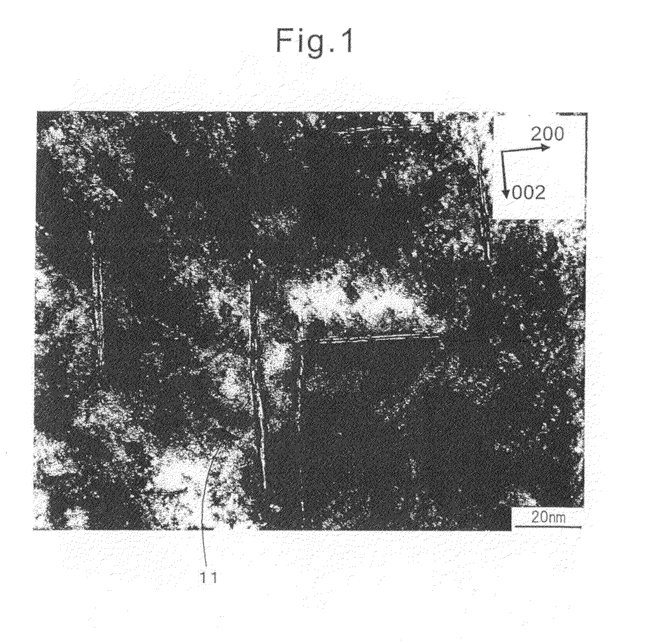

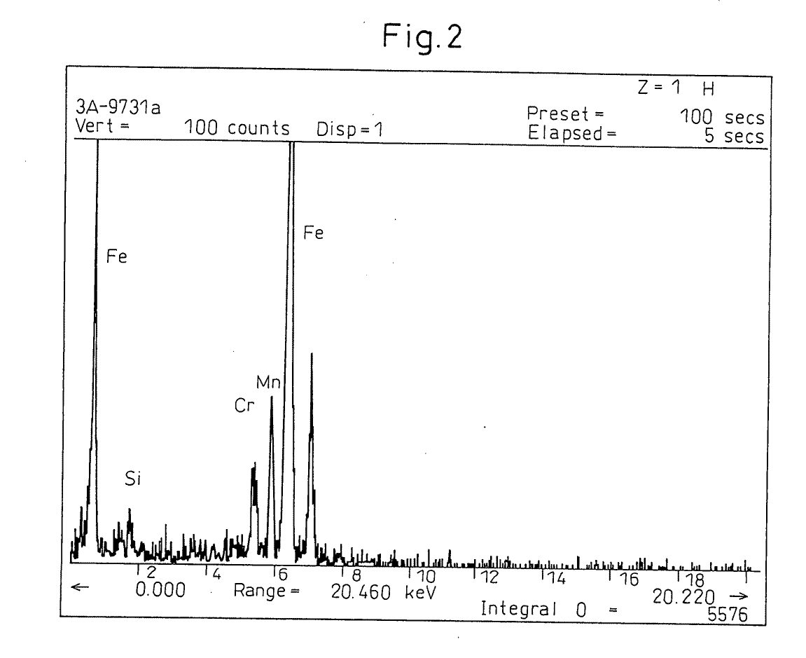

The results of examination by a transmission electron microscope of the effective case hardening of a part obtained by nitrocarburizing CrMn steel according to the prior art are shown in FIG. 1. The results of analysis by an X-ray element analyzer of the ingredients in the Cr carbonitrides at the effective case hardening part are shown in FIG. 2.

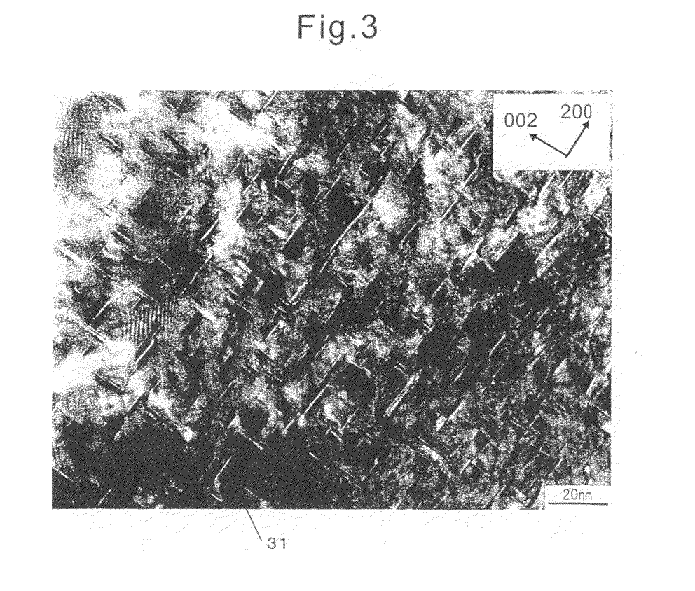

The results of examination by a transmission microscope of the effective case hardening of a part obtained by nitrocarburizing CrMoV steel according to the present invention are shown in FIG. 3. It is learned that compared with the results of the prior art, fine Cr carbonitrides precipitate in greater numbers and sufficient precipitation strengthening occurs.

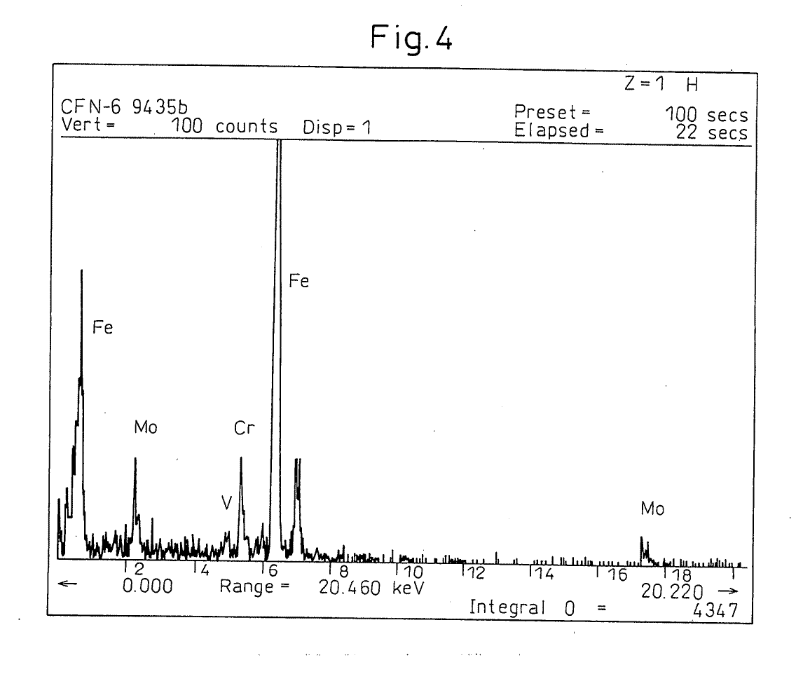

FIG. 4 shows the results of analysis using an X-ray element analyzer of the ingredients in the Cr carbonitrides at the effective case hardening part of a part according to the present invention. It is learned that the Cr carbonitrides contain Mo and V.

### EXAMPLES

Steels having the compositions of ingredients shown in Table 1 were produced.

In each of the examples shown in Table 2, a thickness 50 mm steel slab was hot rolled under the conditions shown in Table 2 to obtain a thickness 25 mm steel plate. This was then cut to a 410 mm test piece which was cold forged to obtain a cold forged part of a thickness of 10 mm and a diameter of 14 mm.

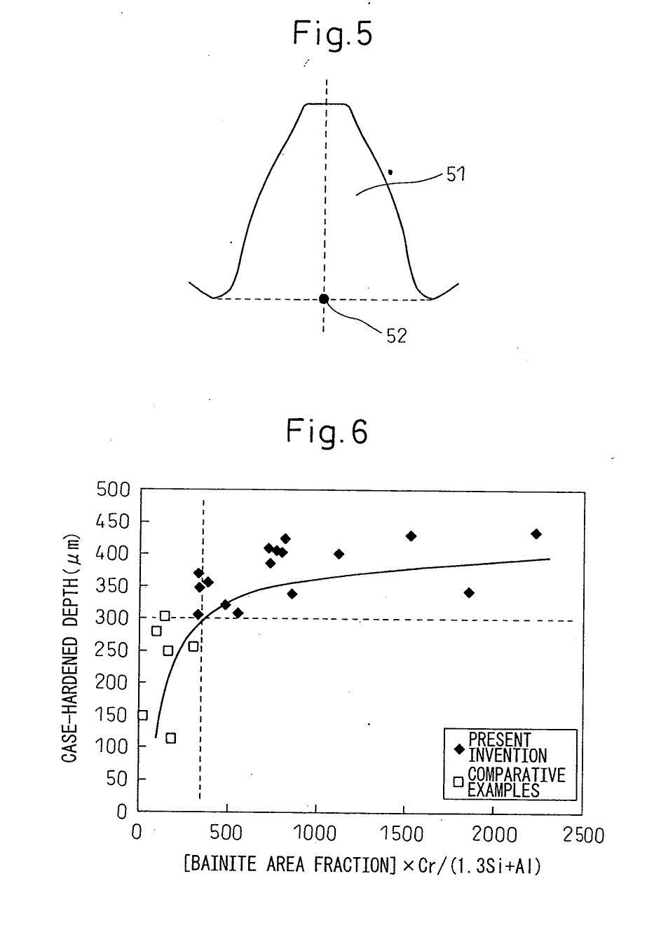

In each of the examples shown in Table 3, a 425 mm steel bar was hot forged under the conditions shown in Table 3 to obtain a hot forged part of a thickness of 10 mm and a diameter of 35 mm. The hot forged part was cut to a gear shape after forging. FIG. 5 shows the shape of one tooth 51 of the gear.

In Tables 1 to 3, the underlined numerical values and symbols indicate ones outside the scope of the present invention.

TABLE 1

| | | | | | | | | | | | Harden- | |
|---|---|---|---|---|---|---|---|---|---|---|---|---|
| | | | | | | | | | | | ability | |
| Steel | Chemical ingredients (mass %) | | | | | | | | | | Multiplying | |
| type | C | Si | Mn | Al | Cr | Mo | V | Ti | Nb | B | factor | Remarks |
| A | 0.02 | 0.05 | 2.9 | 0.02 | 2.1 | 0.71 | 0.40 | 0.021 | | 0.0020 | 310 | Inv. ex. |
| B | 0.05 | 0.04 | 1.8 | 0.08 | 1.9 | 0.45 | 0.19 | | | | 218 | |
| C | 0.08 | 0.06 | 1.8 | 0.03 | 1.2 | 0.51 | 0.08 | | | | 210 | |
| D | 0.10 | 0.05 | 2.0 | 0.03 | 0.9 | 0.22 | 0.12 | | | | 136 | |
| E | 0.15 | 0.05 | 2.1 | 0.03 | 1.1 | 0.83 | | | | | 427 | |
| F | 0.27 | 0.06 | 1.0 | 0.04 | 1.0 | | 0.11 | | | | 79 | |
| G | 0.05 | 0.09 | 1.7 | 0.11 | 1.2 | 0.55 | 0.20 | 0.012 | 0.010 | 0.0014 | 169 | |
| H | 0.09 | 0.01 | 1.2 | 0.24 | 1.5 | 1.30 | 0.80 | | 0.015 | 0.0008 | 353 | |
| I | 0.14 | 0.04 | 0.7 | 0.06 | 2.7 | 1.02 | | | | | 394 | |
| J | 0.12 | 0.06 | 2.0 | 0.07 | 0.6 | | 0.15 | | | | 69 | |
| K | 0.11 | 0.04 | 1.5 | 0.03 | 1.1 | 0.24 | 0.19 | | | | 131 | |
| L | 0.11 | 0.05 | 1.6 | 0.03 | 1.1 | 0.24 | 0.20 | | 0.241 | | 140 | |
| M | 0.09 | 0.02 | 1.3 | 0.04 | 1.4 | 0.29 | 0.15 | 0.237 | | 0.0042 | 135 | |
| N | 0.14 | 0.01 | 1.1 | 0.26 | 1.0 | 0.24 | 0.42 | | | | 105 | |
| O | 0.18 | 0.02 | 1.2 | 0.15 | 1.0 | | 0.30 | | | | 73 | |
| P | 0.21 | 0.01 | 0.9 | 0.21 | 1.0 | 0.23 | 0.30 | | | | 107 | |
| Q | 0.005 | 0.06 | 1.0 | 0.04 | 1.1 | 0.31 | 0.11 | | | | 23 | Comp. ex |
| R | 0.40 | 0.05 | 1.2 | 0.54 | 2.1 | | 0.23 | | | | 197 | |
| S | 0.12 | 0.21 | 1.3 | 0.06 | 0.7 | 0.26 | | | | | 103 | |
| T | 0.08 | 0.07 | 0.2 | 0.03 | 0.1 | 0.24 | 0.09 | | | | 10 | |
| U | 0.14 | 0.04 | 3.8 | 0.24 | 0.8 | 0.42 | 0.28 | | | | 365 | |
| V | 0.16 | 0.05 | 0.6 | 0.23 | 0.7 | 0.08 | 0.02 | | | | 41 | |

The hardness after hot rolling was found, in accordance with JIS Z 2244, by cutting and polishing a test piece so that its L cross-section appeared and measuring the HV0.3 (2.9N) at a position of ¼ the diameter. The hardness after hot forging was found by measuring the HV0.3 at the position shown by 52 in FIG. 5.

The area fraction of the bainite after hot rolling was found by mirror polishing a sample, then etching it by a Nital solution, observing and photographing by an optical microscope five fields of regions corresponding to the above positions for measurement of hardness at a power of 500×, visually determining the bainite parts, and analyzing these by image analysis.

The nitrocarburization was gas soft-nitriding in a volume ratio NH₃:N₂:CO=50:45:5 mixed gas under conditions of 580° C.×10 hr.

The surface layer hardness was made HV0.3 at a position 50 μm inside from the surface.

The effective case-hardened depth, with reference to JIS G 0557, was made a distance from the surface layer to the position where HV became 550.

Further, a thin film test piece was prepared from the effective case hardening part and examined at the case hardening part using a transmission electron microscope. As a result, fine Cr carbonitrides were observed at the case hardened part.

Furthermore, an X-ray element analyzer was used to analyze the ingredients of the Cr carbonitrides and investigate if the Cr carbonitrides contained one or both of Mo and V. The precision of the X-ray element analyzer used in the examples is one enabling detection of elements contained in amounts of 0.5% or more.

TABLE 2

| | | | | | | | Effective | | | |
|---|---|---|---|---|---|---|---|---|---|---|
| | | | | Hardness | Bainite | Surface | case | | | |
| | | Heating | Cooling | after hot | area | layer | hardening | | | |
| | Steel | temp. | rate | rolling | fraction | hardness | depth | Mo—V | A * Cr/ | |
| No. | type | (° C.) | (° C./s) | (Hv) | (%) A | (Hv) | (μm) | Contents | (1.3Si + Al) | Remarks |
| 1 | A | 1150 | 3 | 196 | 90 | 852 | 436 | Yes | 2224 | Inv. ex. |
| 2 | B | 1050 | 1 | 188 | 78 | 873 | 402 | Yes | 1123 | |
| 3 | C | 1050 | 0.8 | 206 | 73 | 786 | 425 | Yes | 811 | |
| 4 | D | 1050 | 1 | 204 | 84 | 727 | 403 | Yes | 796 | |
| 5 | E | 1050 | 0.3 | 185 | 74 | 731 | 339 | Yes | 857 | |
| 6 | F | 1050 | 1 | 210 | 86 | 779 | 386 | Yes | 729 | |
| 7 | I | 1050 | 3 | 175 | 77 | 827 | 343 | Yes | 1856 | |
| 8 | J | 1050 | 1 | 207 | 81 | 745 | 307 | Yes | 328 | |
| 9 | K | 1050 | 0.8 | 194 | 57 | 804 | 406 | Yes | 765 | |
| 10 | N | 1050 | 0.8 | 243 | 89 | 860 | 370 | Yes | 326 | |
| 11 | O | 1050 | 1 | 215 | 59 | 766 | 348 | Yes | 335 | |
| 12 | P | 1050 | 0.8 | 242 | 85 | 823 | 357 | Yes | 381 | |
| 31 | Q | 1050 | 3 | 130 | 33 | 711 | 256 | Yes | 308 | Comp. ex. |
| 32 | R | 1050 | 3 | 382 | 53 | 968 | 112 | Yes | 184 | |
| 33 | S | 1050 | 10 | 196 | 78 | 722 | 249 | No | 164 | |
| 34 | T | 1150 | 3 | 117 | 26 | 620 | 147 | Yes | 21 | |
| 35 | K | 1050 | 0.05 | 113 | 23 | 799 | 271 | Yes | 309 | |
| 36 | G | 920 | 1 | 134 | 48 | 811 | 283 | Yes | 254 | |

TABLE 3

| | | | | | | | Effective | | | |
|---|---|---|---|---|---|---|---|---|---|---|
| | | | | Hardness | Bainite | | case | | | |
| | | Heating | Cooling | after hot | area | Surface | hardened | | | |
| | Steel | temp. | rate | forging | fraction | hardness | depth | Mo—V | A * Cr/ | |
| No. | type | (° C.) | (° C./s) | (Hv) | (%) | (Hv) | (μm) | Contents | (1.3Si + Al) | Remarks |
| 21 | G | 1250 | 1 | 172 | 91 | 904 | 321 | Yes | 481 | Inv. ex. |
| 22 | H | 1200 | 1 | 186 | 93 | 937 | 309 | Yes | 551 | |
| 23 | L | 1250 | 1 | 198 | 62 | 736 | 410 | Yes | 718 | |
| 24 | M | 1250 | 10 | 194 | 72 | 732 | 431 | Yes | 1527 | |
| 41 | U | 1200 | 1 | 331 | 52 | 909 | 302 | Yes | 142 | Comp. ex. |
| 42 | V | 1200 | 5 | 142 | 41 | 881 | 279 | No | 97 | |

Nos. 1 to 12 of Table 2 and Nos. 21 to 24 of Table 3 are examples of the present invention. They gave cold forged parts and hot forged parts of a HV700 or more surface layer hardness and a 300 μm or more effective case-hardened depth.

Nos. 31 and 34 had amounts of C and amounts of Mn lower than the lower limits prescribed in the present invention, so had bainite area fractions of less than 50% and effective case hardenings shallower than the effective case hardenings of the invention examples.

No. 32 had an amount of aluminum over the upper limit prescribed in the present invention, while No. 33 had an amount of Si over the upper limit prescribed in the present invention, so both had effective case hardenings shallower than the effective case hardenings of the invention examples. In No. 33, the reason why the Cr carbonitrides did not contain Mo and V is believed to be the amounts of addition of No and V and the bainite area fraction were low.

No. 42 had an amount of Mo and an amount of V lower than the lower limits prescribed in the present invention, so had a bainite area fraction of less than 50%. The Cr carbonitrides did not include Mo and V, so the effective case hardening was shallower than the effective case hardenings of the invention examples.

Nos. 32 and 41 had amounts of C and amounts of Mn over the upper limit prescribed in the present invention, so became extremely high in hardness after hot rolling and after hot forging and therefore are not preferable from the viewpoint of the increase in costs of subsequent forging or cutting work.

No. 35 had a slow cooling rate of hot rolling, while No. 36 had a low heating temperature of hot rolling, so are believed to have had bainite area fractions of less than 50%. Therefore, the effective case hardenings were shallower than the effective case hardenings of the invention examples.

FIG. 6 shows the relationship between the [bainite area fraction]×Cr/(1.3Si+Al) and the effective case-hardened depth in the present invention examples and comparative examples. As will be understood from FIG. 6, there is a close relationship between the two. Using steel for nitrocarburizing where the bainite area fraction (%) and the contents (mass %) of Si, Cr, and Al satisfy [bainite area fraction]×Cr/(1.3Si+Al)>350 is effective for obtaining nitrided parts having an effective case-hardened depth of 300 μm or more.

### REFERENCE SIGNS LIST

11. Cr carbonitrides
31. Cr carbonitrides containing Mo and V
51. One tooth in gear
52. Measurement position of hardness after hot forging

1. Steel for nitrocarburizing characterized by containing, by mass %, C: 0.01 to 0.3%, Si: less than 0.1%, Mn: 0.4 to 3%, Cr: 0.5 to 3%, and Al: 0.01 to 0.3%, further containing one or both of Mo: 0.2 to 1.5% and V: 0.05 to 1.0%, having a balance of Fe and unavoidable impurities, and comprised of a structure having, by area fraction, 50% or more of bainite.

2. Steel for nitrocarburizing as set forth in claim 1, characterized in that an area fraction (%) of bainite and contents (mass %) of Si, Cr, and Al satisfy
[bainite area fraction]×Cr/(1.3Si+Al)>350.

3. Steel for nitrocarburizing as set forth in claim 1, characterized in that contents (mass %) of C, Mn, Si, Cr, and Mo satisfy
$$65 ≦ 8.65 \times \sqrt{C} \times ( 1 + 4.1 Mn ) \times ( 1 + 0.64 Si ) \times ( 1 + 2.33 Cr ) \times ( 1 + 3.14 Mo ) ≦ 450$$

4. Steel for nitrocarburizing as set forth in claim 1, characterized by further containing, by mass %, one or both of Ti: 0.01 to 0.3% and Nb: 0.01 to 0.3%.

5. Steel for nitrocarburizing as set forth in claim 1, characterized by further containing B: 0.0005 to 0.005%.

6. Steel for nitrocarburizing as set forth in claim 1, characterized in that a content of Mn is, by mass %, 1.5 to 3%.

7. Steel for nitrocarburizing as set forth in claim 1, characterized by further containing one or both of Mo: 0.2 to 1.5% and V: 0.5 to 1.0%.

8. A nitrocarburized part characterized by containing, by mass %, C: 0.01 to 0.3%, Si: less than 0.1%, Mn: 0.4 to 3%, Cr: 0.5 to 3%, and Al: 0.01 to 0.3%, further containing one or both of Mo: 0.2 to 1.5% and V: 0.05 to 1.0%, having a balance of Fe and unavoidable impurities, comprised of a structure having, by area fraction, 50% or more of bainite, having a nitrided layer at its surface, having an effective case-hardened depth of 300 or more, and containing one or both of Mo and V in Cr carbonitrides precipitated in the steel.

9. A nitrocarburized part as set forth in claim 8 characterized in that an area fraction (%) of bainite and contents (mass %) of Si, Cr, and Al satisfy
[bainite area fraction]×Cr/(1.3Si+Al)>350.

10. A nitrocarburized part as set forth in claim 8, characterized in that contents (mass %) of C, Mn, Si, Cr, and Mo satisfy
$$65 ≦ 8.65 \times \sqrt{C} \times ( 1 + 4.1 Mn ) \times ( 1 + 0.64 Si ) \times ( 1 + 2.33 Cr ) \times ( 1 + 3.14 Mo ) ≦ 450$$

11. A nitrocarburized part as set forth in claim 8, characterized by further containing, by mass %, one or both of Ti: 0.01 to 0.3% and Nb: 0.01 to 0.3%.

12. A nitrocarburized part as set forth in claim 8, characterized by further containing B: 0.0005 to 0.005%.

13. A nitrocarburized part as set forth in claim 8, characterized in that a content of Mn is, by mass %, 1.5 to 3%.

14. A nitrocarburized part as set forth in any of claim 8, characterized by further containing one or both of Mo: 0.2 to 1.5% and V: 0.5 to 1.0%.
